(19) United States
(12) Patent Application Publication
(10) Pub. No.: US 2023/0329282 A1
(43) Pub. Date: Oct. 19, 2023

(54) Application of 1-Deoxynojirimycin in Feed for Improving Nutritional Value and Sensory Effect of Rabbit Meat Products

(71) Applicants: Jiangsu University of Science and Technology, Zhenjiang (CN); Zhenjiang Yuankai Biotechnology Co., Ltd., Zhenjiang (CN)

(72) Inventors: Qirui Hou, Zhenjiang (CN); Wenyu Hou, Zhenjiang (CN); Xia Hu, Zhenjiang (CN); Xiaoqing Li, Zhenjiang (CN); Zijie Jiang, Zhenjiang (CN); Shaocong Li, Zhenjiang (CN); Weiguo Zhao, Zhenjiang (CN); Xiangdong Zeng, Zhenjiang (CN)

(21) Appl. No.: 18/336,971

(22) Filed: Jun. 17, 2023

(30) Foreign Application Priority Data
Mar. 17, 2023 (CN) 202310261207.3

(51) Int. Cl. A23K 20/132

(52) U.S. Cl. CPC A23K 20/132

(57) ABSTRACT

The present invention provides an application of 1-deoxynojirimycin in feed for improving the nutritional value and sensory effect of rabbit meat products, and belongs to the technical field of feed. In the present invention, 1-deoxynojirimycin (DNJ) is added to meat rabbit feed, the addition of 0.14-0.28 g/kg DNJ to meat rabbit feed can significantly improve the quality and sensory effect of rabbit meat and the antioxidant capacity of animal meat products and prolong the shelf life, and 1-deoxynojirimycin is an effective component to improve the nutritional value and sensory effect of animal meat products and is beneficial to human health.

### TECHNICAL FIELD

The present invention relates to the technical field of feed, in particular to an application of 1-deoxynojirimycin in feed for improving the nutritional value and sensory effect of rabbit meat products.

### BACKGROUND

The leaves of mulberry (Morus alba L.) have high nutritional value, which are known as a storehouse of natural plant nutrients, and have the main nutrients higher than common herbage and the digestibility up to 80%-95%, and thus are a kind of ideal animal feed, which have obtained a good application effect in the breeding of pigs, rabbits, poultry and ruminants. Researches show that adding mulberry leaves to feed can significantly affect the quality of animal meat.

1-deoxynojirimycin (DNJ) is a kind of a-glucosidase inhibitor highly enriched in mulberry leaves, which competitively inhibits the glucose absorption of animals in the small intestine, reduces the mRNA expression of receptor protein CD36 responsible for fatty acid transmembrane transport and transcription factor C/EBPα involved in fat synthesis, promotes fatty acid oxidation, and has a strong regulation effect on the glucolipid metabolism in the animal body. Researches show that DNJ has good effects of lowering blood glucose and blood lipid and reducing weight, and can be used to treat type 2 diabetes, obesity and other related glucose and lipid metabolism disorders. Kong et al. find that DNJ can significantly improve the fasting blood glucose level in rats with spontaneous persistent hyperglycemia, especially significantly enhance insulin sensitivity, and prevent the increase of body mass in rats with hyperglycemia. DNJ also can activate the (3-oxidation system and inhibit liver lipid accumulation. Researches show that DNJ also has the function of improving the anti-inflammatory ability of the body.

At present, 1-deoxynojirimycin is used in animal feed, which affects the growth performance, the slaughter performance, the apparent digestibility of main nutrients and the serum biochemical indexes of animals by affecting the carbohydrate metabolism and fat deposition of the body.

However, the application of 1-deoxynojirimycin in feed for improving the nutritional value and sensory effect of rabbit meat products has not been reported by far.

### SUMMARY

In view of this, to improve the nutritional value and sensory effect of rabbit meat products, the present invention provides an application of 1-deoxynojirimycin in feed for improving the nutritional value and sensory effect of rabbit meat products, which can improve the content of unsaturated fatty acid (USFA) and antioxidant capacity of rabbit meat and make the meat color dark red, and can be considered as an effective component to improve the nutritional value and sensory effect of rabbit meat products.

To achieve the above purpose, the present invention provides the following technical solution:

An application of 1-deoxynojirimycin in feed for improving the nutritional value and sensory effect of rabbit meat products.

Preferably, the additive amount of the 1-deoxynojirimycin in meat rabbit feed is 0.14-0.28 g/kg.

Preferably, the additive amount of the 1-deoxynojirimycin in meat rabbit feed is 0.28 g/kg.

In the present invention, 1-deoxynojirimycin is added to meat rabbit feed, which has the following beneficial effects:
1) The content of saturated fatty acid (SFA) in rabbit meat is decreased, and the content of polyunsaturated fatty acid (PUFA) is increased, where the increase of the contents of linoleic acid (C18:2n6c), arachidonic acid (C20:4n6c) and DPA (C22:5n6c) is beneficial to human health;
2) The redness α* of rabbit meat is enhanced, and the sensory effect is improved to attract consumers;
3) The activity of glutathione peroxidase (GSH-Px) and total antioxidant capacity (T-AOC) enzyme in rabbit meat is increased, and the antioxidant capacity of animal meat products is improved, which is conducive to extending the shelf life.

In conclusion, the addition of 0.14-0.28 g/kg DNJ to meat rabbit feed can significantly improve the quality and sensory effect of rabbit meat and the antioxidant capacity of animal meat products and prolong the shelf life, and 1-deoxynojirimycin is an effective component to improve the nutritional value and sensory effect of animal meat products and is beneficial to human health.

### DETAILED DESCRIPTION

The technical solution of the present invention is clearly explained below in detail in combination with specific experiments.

1. Materials and Methods

1.1 Test Materials (with New Zealand White Rabbits as Experimental Subjects)

Mulberry leaf DNJ is purchased from Shanghai Traditional Chinese Medicine Reference Experimental Consumables Center, and the content of DNJ is greater than or equal to 98% as detected by HPLC; and New Zealand white rabbits are derived from the Experimental Rabbit Farm of Jiangsu Academy of Agricultural Sciences.

1.2 Test Methods

The single-factor completely randomized test design is adopted. 36 45-day-old healthy New Zealand white rabbits (male) with the average weight of (1.05±0.04) kg are selected and randomly divided into 3 groups, and each group has 12 replicates with 1 rabbit per replicate. A control group is fed with a basal diet, an L-DNJ group is fed with the basal diet+0.14 g/kg DNJ, and an H-DNJ group is fed with the basal diet+0.28 g/kg DNJ. The composition and nutrient levels of the basal diet are shown in Table 1. The diet is uniformly mixed to be prepared into cylindrical particles with the diameter of 6 mm and the length of 1 cm. The preliminary trial period is 14 d, and the trial period is 28 d.

In the present invention, the additive amount of DNJ in the daily ration is set to 0.14 g/kg and 0.28 g/kg, which is equivalent to adding 5.4% and 10.8% of mulberry leaves.

Before the test, rabbit houses and cages are cleaned and disinfected, rabbits are immunized according to routine procedures, and the rabbit houses are naturally ventilated and illuminated. Each experimental rabbit is raised in a single cage and fed with a diet and water twice a day at fixed time (8:00 am and 17:00 pm), and is free to eat and drink.

TABLE 1
Composition and Nutrient Levels of Basal Diet (Air Dry)

| Raw Material | Content (%) | Nutrient Level | Content (%) |
|---|---|---|---|
| Alfalfa meal | 16.09 | Digestible energy (DE) (MJ/kg)² | 11.23 |
| Corn | 21.41 | Crude protein (CP) | 17.91 |
| Soybean meal | 15.34 | Crude fiber (CF) | 14.86 |
| Bran | 22.32 | Neutral detergent fiber (NDF) | 32.82 |
| Unite bran | 18.03 | Acid detergent fiber (ADF) | 20.47 |
| Soybean oil | 3.01 | Acid detergent lignin (ADL) | 7.08 |
| Calcium hydrophosphate | 0.40 | Ether extract (EE) | 3.39 |
| Stone powder | 1.50 | Crude ash | 7.67 |
| Salt | 0.50 | Calcium (Ca) | 1.05 |
| L-lysine | 0.10 | Total phosphorus (TP) | 0.51 |
| DL-methionine | 0.30 | Lysine | 0.88 |
| Premix feed | 1.00 | Methionine + cystine | 0.68 |

Note:
The premix feed provides each kilogram of daily ration with: 30 mg of Fe, 6 mg of Cu, 35 mg of Zn, 8 mg of Mn, 0.05 mg of Se, 0.3 mg of Co, 0.4 mg of I, 6000 IU of VA, 900 IU of VD, 15 IU of VE, 1 mg of VK3, 100 μg of biotin, 100 mg of choline, 0.5 mg of pyridoxine, 3 mg of riboflavin, 9 μg of VB12, 35 mg of nicotinic acid and 8 mg of pantothenic acid.

1.3 Measurement Index and Detection Method

1.3.1 Meat Quality

The rabbits are deprived of food (but not water) on the night of the end of the experiment, and after weighing in the next morning, 8 rabbits with similar weight are selected from each group and slaughtered. The longissimus dorsi muscles of the rabbits are collected, the pH values of the front, middle and back parts of the longissimus dorsi muscle are measured with a pH meter (Bante221, Shanghai Bante Instrument Co., Ltd.) having the function of automatic temperature compensation and then measured again after standing at room temperature for 24 h, and the pH decreased values of the muscle within 24 h are calculated. The pH value is the average value of the three readings. The meat color (L*, α*, b*) is measured with a TC-PIIG automatic color difference meter (Beijing Aoyike Photoelectric Instrument Co., Ltd.) on the muscle surface. The detection light source is D65 according to CIE laboratory standards, and the measurement area is 8 mm in diameter. The average value is obtained by making three measurements at each detection point.

About 20 g of meat sample is weighed (demoted as M1), hung with a thin thread, and covered with a plastic bag with the mouth sealed, enough space is left inside to accommodate oozy water drops, and the meat sample is hung in a 4° C. refrigerator for 24 h. After being taken out, the meat sample is weighed (denoted as M2) after the surface moisture is absorbed with absorbent paper. 3 parallel samples are measured for each rabbit, and the results are averaged. Drip loss=(M1−M2)/M1×100%.

Another meat sample is trimmed into a 1 cm×1 cm×2.5 cm meat strip, the shear force is measured in the direction perpendicular to the muscle fibers by a TMS-PRO texture analyzer (FTC Corporation, USA) for three times, and the results are averaged.

The contents of moisture, crude protein and ether extract in the muscle are measured according to the method proposed by Zhang Liying (Zhang Liying. Feed analysis and feed quality inspection technology [M]. 4^{th} Ed. Beijing: China Agricultural University Press, 2016).

1.3.2 Fatty Acid Composition of Muscle

10 g of meat sample is crushed, total fat is extracted after freeze-drying and converted to fatty acid methyl ester using a mixture of boron trifluoride, hexane and methanol (35:20:45 v/v), and then the fatty acid composition and content are measured with a gas chromatograph-mass spectrometer GC/MS (Model 7890-5975, Agilent Technologies, Inc.) with a 60 m×0.25 mm×0.25 μm capillary column. Gas chromatographic conditions are set as follows: the injector temperature is 220° C., and the detector temperature is 275° C.; and the initial column chamber temperature is 140° C. for 5 min, then increased to 240° C. at a rate of 4° C./min and maintained at 240° C. for 15 min. Finally, the fatty acid is measured with a flame ionization detector. The ionization energy is 70 eV, the ion source temperature is 200° C., and the scanning range is 50-500 m/z. The retention time of each peak in the chromatogram is compared with that of a mixed standard of 37 fatty acid methyl esters (B25881, Shanghai Yuanye Bio-technology Co., Ltd.) to determine the properties of each peak. Three measurements are made for each sample, and the results are averaged.

1.3.3 Antioxidation of Muscle

About 5 g of muscular tissue is rinsed in 0-4° C. precooled normal saline to remove blood, dried with filter paper, and then weighed. The muscle tissue and 0-4° C. precooled homogenate buffer are thoroughly mixed and homogenized in an ice water bath at a ratio of 9:1 to prepare muscle tissue homogenate with the mass concentration of 10%. The homogenate buffer contains 0.01 mol/L sucrose, 0.14 mol/L NaCl, 0.01 mol/L Tris-HCl and 0.0001 mol/L Na2EDTA, with the pH value of 7.4. The total protein content and the malondialdehyde (MDA) content of the tissue suspension is detected with a kit by a colorimetric method. Before the activities of total antioxidant capacity (T-AOC) enzyme, superoxide dismutase (SOD) and glutathione peroxidase (GSH-Px) are measured, the homogenate suspension is centrifuged at 3000 r/min for 15 min, the superneant is taken, and the activities of the enzymes are measured with relevant kits. All the kits are from Nanjing Jiancheng Bioengineering Institute, and the operation method is shown in the instructions of kits.

2 Data Statistics and Result Analysis

The test data are preliminarily processed by Microsoft Excel, and then subjected to one-factor analysis of variance and significance test by SPSS 20.0 software. The Duncan's method is used for multiple comparison, and P<0.05 is used as the judgment criterion for significance of difference.

2.1 Effect of Mulberry Leaf DNJ on Quality of Rabbit Meat

TABLE 2
Effect of Mulberry Leaf DNJ on Quality of Rabbit Meat

| | Group | | | Standard | |
|---|---|---|---|---|---|
| Item | Control | L-DNJ | H-DNJ | Error | P Value |
| pH value | | | | | |
| pH₄₅ₘᵢₙ | 6.61 | 6.62 | 6.77 | 0.031 | 0.172 |
| pH_{24 h} | 5.82 | 5.87 | 5.89 | 0.089 | 0.329 |
| pH_{24 h decreased} | 0.80 | 0.76 | 0.87 | 0.035 | 0.435 |
| Meat color | | | | | |
| Brightness L* | 58.42ª | 55.82^{ab} | 55.34^{b} | 0.162 | 0.036 |
| Redness a* | 1.19^{b} | 1.56ª | 1.71ª | 0.016 | 0.035 |
| Yellowness b* | 8.32 | 8.32 | 8.35 | 0.047 | 0.239 |
| Drip loss (%) | 3.63 | 3.56 | 3.17 | 0.044 | 0.368 |
| Shear force (N/cm²) | 32.62 | 32.86 | 33.51 | 0.530 | 0.241 |
| Nutritional ingredient | | | | | |
| of muscle | | | | | |
| Moisture | 75.29 | 75.93 | 75.20 | 0.634 | 0.453 |
| Crude protein (CP) | 21.86 | 22.09 | 22.18 | 0.353 | 0.076 |
| Ether extract (EE) | 3.10ª | 2.50^{b} | 0.60^{c} | 0.034 | 0.014 |

Different lowercase letters on the shoulder letters of the data in the same row indicate significant difference (P<0.05), and the same letter or no letter indicates no significant difference (P>0.05). See the following table.

It can be known from Table 2 that with the increase of DNJ concentration in the diet, the brightness L* of rabbit meat is decreased and the redness α* is increased, that is, the color of rabbit meat is dark red, which is very consistent with the sensory preference of consumers for meat. However, the research results of Zhong Jingbo et al. (Zhong Jingbo, Hou Qirui, Shen Manman, et al. Effects of mulberry leaf DNJ on growth performance, blood biochemical indexes, slaughter performance and meat quality of New Zealand white rabbits [J]. Feed Industry, 2021,42(13):53-57) show that mulberry leaf DNJ can increase the brightness L* of rabbit meat, and has no effect on the redness α* of rabbit meat.

The reason for the above difference is that the additive amount of mulberry leaf DNJ in the present invention is lower than that proposed by Zhong Jingbo et al. (Zhong Jingbo, Hou Qirui, Shen Manman, et al. Effects of mulberry leaf DNJ on growth performance, blood biochemical indexes, slaughter performance and meat quality of New Zealand white rabbits [J]. Feed Industry, 2021,42(13):53-57) and the antioxidant activity is weaker, which fails to prevent myoglobin from oxidizing and darkening. In addition, the higher the fat content and moisture content of the muscle are, the lighter the meat color is (Refer to MANCINI R A,HUNT M C. Current research in meat color[J].Meat Science,2005,71:100-121.). It can be known from Table 1 and Table 2 that in the present invention, the moisture content of rabbit meat in the DNJ treatment group is almost unchanged, but the fat content is significantly lower than that in the control group, which also has a certain effect on darkening of the meat color. In the present invention, the fat content of rabbit meat in the DNJ treatment group is significantly lower than that in the control group, which presents a dose-response relationship, that is, DNJ has the functions of reducing lipogenesis and promoting lipolysis, and the fundamental reason is that DNJ has the function of regulating lipid metabolism and inhibits the generation of adipocytes through the ERK/PPARy signalling pathway. DNJ also can increase the mRNA expression of PPARa and AMPK genes, enhance the activity and mRNA expression of the liver fatty acid β oxidase, and activate the (3-oxidation system, so as to promote lipolysis and prevent fat accumulation.

The reason is that the free glucose content of the muscle is also associated with darkening of the meat color. Researches show that DNJ can lower the mRNA expression of sodium/glucose cotransporter 1 (SGLT1), glucose transporter 2 (GLUT2) and Na/K-ATP enzyme, reduce the absorption of glucose in the intestinal tract, and decrease the expression of phosphoenolpyruvate carboxykinase (PEPCK), that is a key enzyme in gluconeogenesis, and glucose-6-phosphatase (G-6-Pase), so as to lower the free glucose level of the muscle and darken the meat color.

2.2 Effect of mulberry leaf DNJ on fatty acid composition of rabbit meat

TABLE 3
Effect of Mulberry Leaf DNJ on Fatty Acid Composition of Rabbit Meat

| | | | | Standard | |
|---|---|---|---|---|---|
| | Group | | | Error | P |
| Item | Control | L-DNJ | H-DNJ | SEM | value |

Saturated fatty acid (SFA)/%

| | | | | | |
|---|---|---|---|---|---|
| C10:0 | 0.31 | 0.20 | 0.25 | 0.029 | 0.318 |
| C12:0 | 0.98^{b} | 1.71ª | 0.92^{b} | 0.106 | 0.001 |
| 12Methyl C13:0 | 0.20^{b} | 0.30^{a} | 0.14^{b} | 0.019 | 0.001 |
| C14:0 | 2.11 | 2.16 | 2.14 | 0.147 | 0.784 |
| 9Methyl C14:0 | 0.07 | 0.06 | 0.07 | 0.002 | 0.652 |
| 13Methyl C14:0 | 0.10^{b} | 0.12ª | 0.13ª | 0.004 | 0.008 |
| C15:0 | 0.51 | 0.52 | 0.53 | 0.022 | 0.956 |
| 14Methyl C15:0 | 0.27 | 0.27 | 0.26 | 0.012 | 0.958 |
| C16:0 | 29.50ª | 30.16ª | 26.52^{b} | 0.438 | <0.001 |
| 14methyl C16:0 | 0.10 | 0.11 | 0.10 | 0.004 | 0.591 |
| C17:0 | 0.47^{b} | 0.46^{b} | 0.52ª | 0.007 | <0.001 |
| C18:0 | 7.41ª | 8.22ª | 5.11^{b} | 0.399 | 0.001 |
| C20:0 | 0.13 | 0.11 | 0.11 | 0.007 | 0.515 |

Monounsaturated fatty acid (MUFA)/%

| | | | | | |
|---|---|---|---|---|---|
| C16:1n9c | 0.46 | 0.51 | 0.42 | 0.021 | 0.249 |
| C16:1n7c | 2.53 | 1.89 | 2.06 | 0.181 | 0.341 |
| C17:1n7c | 0.25 | 0.22 | 0.21 | 0.010 | 0.218 |
| C18:1n9c | 22.43ª | 20.60^{b} | 23.01ª | 0.405 | 0.031 |
| C18:1n9t | 1.13^{b} | 1.08^{b} | 2.86ª | 0.144 | 0.049 |
| C20:1n9t | 0.14^{b} | 0.16^{b} | 0.24^{a} | 0.011 | <0.001 |

Polyunsaturated fatty acid (PUFA)/%

| | | | | | |
|---|---|---|---|---|---|
| C16:3n4c | 0.11^{b} | 0.13^{b} | 0.19ª | 0.008 | <0.001 |
| C18:2n6c | 29.99^{b} | 28.40^{b} | 31.77ª | 0.564 | 0.005 |
| C20:4n6c | 1.52^{b} | 1.61^{b} | 2.67ª | 0.147 | 0.016 |
| C20:3n6c | 0.16 | 0.15 | 0.43 | 0.060 | 0.077 |
| C20:2n6c | 0.71ª | 0.44^{b} | 0.57^{ab} | 0.036 | 0.005 |
| C22:4n6c | 0.38 | 0.39 | 0.31 | 0.017 | 0.065 |
| C22:5n6c | ND | ND | 0.13 | | |
| Saturated fatty acid (SFA)/% | 42.11ª | 44.48ª | 36.75^{b} | 0.871 | <0.001 |
| Monounsaturated fatty acid (MUFA)/% | 26.24 | 24.45 | 27.13 | 0.551 | 0.080 |
| Polyunsaturated fatty acid (PUFA)/% | 32.52^{b} | 31.12^{b} | 36.07ª | 0.696 | 0.001 |
| Unsaturated fatty acid (UFA)/% | 58.76^{b} | 55.57^{b} | 63.20ª | 0.880 | <0.001 |

ND = not detected.

It can be known from Table 3 that the fatty acid composition and content of rabbit meat are detected by GC/MS, and a total of 26 fatty acids are detected, including 13 saturated fatty acids (SFAs), 6 monounsaturated fatty acids (MUFAs) and 7 polyunsaturated fatty acids (PUFAs). According to the statistical analysis, especially with high-concentration DNJ (0.28 g/kg), the content of SFA (P<0.001) in rabbit meat is significantly decreased, and the contents of PUFA (P=0.001) and the unsaturated fatty acid (UFA, P<0.001) are increased.

It can be known from Table 3 that in the present invention, mulberry leaf DNJ can significantly decrease the content of SFA in rabbit meat and increase the content of PUFA in rabbit meat. The effect of DNJ on the fatty acid composition of rabbit meat is associated with the function thereof in the regulation of glucolipid metabolism in animals.

Linoleic acid (C18:2n6c) has the functions of reducing blood lipid, softening blood vessels, lowering blood pressure and promoting microcirculation, which can prevent or reduce the incidence of cardiovascular diseases; arachidonic acid (C20:4n6c) is an important substance in human brain and optic nerve development, and plays an important role in human intelligence and optic nerve sensitivity; and docosapentaenoic acid (DPA, C22:5n6c) is beneficial to human health in many aspects such as anti-inflammation, inhibition of cytokine synthesis, reduction of thrombosis, lowering of blood lipid and inhibition of atherosclerosis.

In the present invention, the contents of linoleic acid (C18:2n6c) and arachidonic acid (C20:4n6c) in rabbit meat can be significantly increased by adding 0.14-0.28 g/kg mulberry leaf DNJ to the feed, and when the additive amount is 0.28 g/kg, the content of DPA (C22:5n6c) can be detected, which indicates that mulberry leaf DNJ has the potential to be used as feed additive to produce meat products more beneficial to human health.

However, most of the researches in the prior art focus on domestic pigs, and researches on the effects of DNJ on meat quality and fatty acid composition and researches on the antioxidation are not involved.

2.3 Effect of Mulberry Leaf DNJ on Antioxidation of Rabbit Meat

TABLE 4
Effect of Mulberry Leaf DNJ on Antioxidant Indexes of Rabbit Meat

| | Group | | | Standard | |
|---|---|---|---|---|---|
| Item | Control | L-DNJ | H-DNJ | Error | P Value |
| T-AOC(U/mg prot) | 0.68^{b} | 0.78^{ab} | 0.82ª | 0.016 | 0.026 |
| SOD(U/mg prot) | 24.66 | 25.01 | 25.91 | 0.303 | 0.213 |
| GSH-Px(U/mg prot) | 5.75^{c} | 6.36^{b} | 7.88ª | 0.642 | 0.007 |
| MDA(nmol/mg prot) | 0.43 | 0.41 | 0.45 | 0.068 | 0.131 |

It can be known from Table 4 that mulberry leaf DNJ significantly increases the activity of the GSH-Px enzyme of rabbit meat (P=0.007), and high-concentration DNJ (0.28 g/kg) significantly increases the activity of the T-AOC enzyme (P=0.026), but has no significant effect on the activity of the SOD enzyme and the production of MDA (P>0.05).

In the present invention, the effect of mulberry leaf DNJ on animal meat products can be directly reflected by detecting the antioxidant indexes of rabbit meat. It is found in the present invention that mulberry leaf DNJ can improve the antioxidant capacity of muscle tissue to a certain extent and is conducive to extending the shelf life of animal meat products, which is especially important for rabbit meat with high PUFA content, because PUFA is easy to be oxidized in the air, resulting in rancidity of meat products.

In addition, the present invention also studies the effect of DNJ on the growth performance of New Zealand white rabbits and the effect of DNJ on the apparent digestibility of rabbit nutrients, specifically as follows:

Growth Performance

In the morning of the first day of the trial period and the second day after the trial, the experimental rabbits are weighed once on an empty stomach, and the average daily gain (ADG) of each rabbit is calculated. Leftovers are collected and weighed before feeding, and the average daily feed intake (ADFI) of each rabbit is calculated. The ratio of the average daily feed intake to the average daily gain is the feed conversion rate (FCR). The calculation formula is as follows:
ADG=(final weight−initial weight)/test days;
ADFI=total feed intake/test days;
FCR=ADFFADG.

Apparent Digestibility of Nutrients

On the 14^{th} day of the test, 8 experimental rabbits with similar weight are randomly selected from each group and transferred to metabolism cages for digestion and metabolism tests. The digestion and metabolism tests are conducted by the total collection method. All fecal samples of the experimental rabbits are collected for 3 consecutive days, and the contents of nutrients in the diet and fecal samples are measured according to the method in the book written by Zhang Liying. The calculation formula is: apparent digestibility of a nutrient (%)=(content of the nutrient in diet−content of the nutrient in feces)/content of the nutrient in diet×100.

The data statistics and analysis methods are the same as those for the effects on meat quality, fat composition and antioxidation, and the final test results are as follows:

TABLE 5
Effect of Mulberry Leaf DNJ on Growth Performance of
New Zealand White Rabbits

| | Group | | | Standard | P |
|---|---|---|---|---|---|
| Item | Control | L-DNJ | H-DNJ | Error | Value |
| Average daily feed intake | 146.24 | 145.33 | 140.46 | 0.56 | 0.073 |
| (ADFI) | | | | | |
| Average daily gain (ADG) | 40.24 | 36.18 | 32.66 | 1.64 | 0.170 |
| (g/d) | | | | | |
| Feed conversion rate (FCR) | 0.27 | 0.25 | 0.24 | 0.01 | 0.324 |
| (g/g) | | | | | |

It can be seen from Table 5 that the addition of mulberry leaf DNJ to the diet tends to decrease the average daily feed intake, daily gain and feed conversion rate of New Zealand white rabbits, but does not reach a significant level (P>0.05).

Effect of Mulberry Leaf DNJ on Apparent Digestibility of Rabbit Nutrients

TABLE 6
Effect of Mulberry Leaf DNJ on Nutrient Apparent Digestibility of
New Zealand White Rabbits

| | Group | | | Standard | P |
|---|---|---|---|---|---|
| Item | Control | L-DNJ | H-DNJ | Error | Value |
| Dry matter (DM) | 62.25ª | 61.35^{ab} | 60.79^{b} | 1.237 | 0.037 |
| Crude protein (CP) | 74.78^{b} | 75.17^{ab} | 76.25ª | 1.568 | 0.034 |
| Ether extract (EE) | 81.57ª | 79.84^{ab} | 78.35^{b} | 2.469 | 0.020 |
| Crude ash | 42.07 | 43.44 | 42.23 | 0.550 | 0.357 |
| Crude fiber (CF) | 15.07 | 13.54 | 14.56 | 0.351 | 0.153 |
| Neutral detergent fiber | 20.66 | 21.02 | 20.68 | 0.653 | 0.228 |
| Acid detergent fiber | 13.23 | 12.34 | 14.88 | 0.394 | 0.180 |
| (ADF) | | | | | |

As shown in Table 6, high-concentration DNJ (0.28 g/kg) significantly decreases the apparent digestibility of dry matter (P=0.037) and ether extract (P=0.020) of New Zealand white rabbits and increases the apparent digestibility of crude protein (P=0.034), but has no significant effect on the apparent digestibility of crude ash, crude fiber, neutral detergent fiber and acid detergent fiber (P>0.05).

Effect of Mulberry Leaf DNJ on Growth Performance and Nutrient Apparent Digestibility of New Zealand White Rabbits

Since mulberry leaf DNJ has the functions of lowering blood glucose and regulating lipid metabolism, feeding in a large amount may be detrimental to animal fattening and affect the growth performance.

Zhong Jingbo et al. (Zhong Jingbo, Hou Qirui, Shen Manman, et al. Effects of mulberry leaf DNJ on growth performance, blood biochemical indexes, slaughter performance and meat quality of New Zealand white rabbits [J]. Feed Industry, 2021,42(13):53-57) and Xie Hui et al. (Xie Hui, Li Shaocong, Zhao Weiguo, et al. Effects of mulberry leaf DNJ on intestinal digestive function of rabbits [J]. Anhui Agricultural Sciences, 2022,50(16):58-61,64) find through researches that high-concentration mulberry leaf DNJ (0.4 g/kg and 2 g/kg) can decrease the activity of the duodenal amylase and the digestibility of dry matter and ether extract in diet of New Zealand white rabbits, resulting in slow weight gain of animals.

It is found in the researches of the present invention that DNJ still has the function of changing the utilization of diet nutrients of animals under the normal feeding amount of mulberry leaves so as to affect the growth performance of animals. Dry matter in the diet is organic matter that can be utilized by animals. The higher the digestibility of dry matter is, the more the total nutrients obtained by animals are, otherwise the less the total nutrients are. Fat is the substance with the highest energy content in the diet. The decrease of the apparent digestibility of ether extract indicates that animals will obtain less energy, the body will consume the energy substances (such as glycogen and fat) stored inside to meet the needs of vital movement, and long-term insufficient energy supply will result in body lean and weight loss.

Meanwhile, it is also found in the present invention that DNJ will not reduce the feed intake of animals under the normal feeding amount of mulberry leaves, which is different from the results obtained by Zhong Jingbo et al. (Zhong Jingbo, Hou Qirui, Shen Manman, et al. Effects of mulberry leaf DNJ on growth performance, blood biochemical indexes, slaughter performance and meat quality of New Zealand white rabbits [J]. Feed Industry, 2021,42(13):53-57), indicating that DNJ is not a component in mulberry leaves that affects the feed intake of animals under the normal feeding amount of mulberry leaves.

It can be known from Tables 1-6 that:

1) The addition of mulberry leaf DNJ to the diet can increase the redness α* of rabbit meat (P=0.035), and high-concentration DNJ (0.28 g/kg) significantly decreases the brightness L* of rabbit meat (P=0.036); and mulberry leaf DNJ can also significantly decrease the content of ether extract in rabbit meat (P=0.014), but has no significant effect on the contents of moisture and ether extract in meat, the decreased values of pH45 min and pH24 h, drip loss and shear force (P>0.05).

2) The contents of palmitic acid (C16:0) and linoleic acid (C18:2n6c) are highest in the rabbit meat of each group, followed by oleic acid (18:1n9) and stearic acid (18:0), and high-concentration DNJ (0.28 g/kg) significantly decreases the content of saturated fatty acid (SFA) in rabbit meat (P<0.001) and increases the content of polyunsaturated fatty acid (PUFA) (P=0.001), but has no significant effect on the content of monounsaturated fatty acid (MUFA) (P>0.05).

3) Mulberry leaf DNJ significantly increases the activity of the glutathione peroxidase (GSH-Px) enzyme of rabbit meat (P=0.007), and high-concentration DNJ (0.28 g/kg) significantly increases the activity of the total antioxidant capacity (T-AOC) enzyme (P=0.026), but has no significant effect on the activity of the superoxide dismutase (SOD) enzyme and the production of malondialdehyde (MDA) (P>0.05).

4) when the content of DNJ added to the rabbit feed is 0.14-0.28 g/kg, preferably 0.28 g/kg, the apparent digestibility of dry matter (P=0.037) and ether extract (P=0.020) of New Zealand white rabbits can be significantly decreased, and the apparent digestibility of crude protein (P=0.034) can be increased, without significant effect on the average daily feed intake, the daily gain, the feed conversion rate, and the apparent digestibility of crude ash, crude fiber, neutral detergent fiber and acid detergent fiber (P>0.05).

In conclusion, when the content of DNJ added to the rabbit feed is 0.14-0.28 g/kg, preferably 0.28 g/kg, the redness α* of rabbit meat can be enhanced, and the sensory effect can be improved to attract consumers; mulberry leaf DNJ can decrease the content of SFA in rabbit meat and increase the content of PUFA, where the increase of the contents of linoleic acid (C18:2n6c), arachidonic acid (C20:4n6c) and DPA (C22:5n6c) is beneficial to human health; and the supplementation of mulberry leaf DNJ to the diet can improve the antioxidant capacity of animal meat products to a certain extent and prolong the shelf life.

The above only describes the specific preferred embodiments of the present invention, but the protection scope of the present invention is not limited thereto. Any equivalent replacement or change made by those skilled in the art familiar with the technical field within the technical scope disclosed by the present invention according to the technical solution and the improved conception of the present invention shall be covered within the protection scope of the present invention.

1. An application of 1-deoxynojirimycin in feed for improving the nutritional value and sensory effect of rabbit meat products.

2. The application according to claim 1, wherein the additive amount of the 1-deoxynojirimycin in meat rabbit feed is 0.14-0.28 g/kg.

3. The application according to claim 2, wherein the additive amount of the 1-deoxynojirimycin in meat rabbit feed is 0.28 g/kg.
